(19) United States
(12) Patent Application Publication
(10) Pub. No.: US 2011/0283905 A1
(43) Pub. Date: Nov. 24, 2011

(54) GRAVURE OFFSET PRINTING PRESS

(76) Inventor: Ohra Sakata, Ibaraki (JP)

(21) Appl. No.: 13/106,777

(22) Filed: May 12, 2011

(30) Foreign Application Priority Data
May 18, 2010 (JP) 114005/2010

(51) Int. Cl. B41F 9/00

(52) U.S. Cl. 101/153

(57) ABSTRACT

A gravure offset printing press includes a first gravure plate cylinder, second gravure plate cylinder, blanket cylinder, and impression cylinder. The first gravure plate cylinder includes, on its circumferential surface, a first recess to be filled with ink. The second gravure plate cylinder includes, on its circumferential surface, a second recess which is to be filled with ink and has a width in its circumferential direction, that is larger than that of the first recess. The blanket cylinder comes into contact with the first gravure plate cylinder and the second gravure plate cylinder to receive the inks from the first and the second gravure plate cylinders. The contact position between the second gravure plate cylinder and the blanket cylinder is located upstream, in the rotation direction of the blanket cylinder, of the contact position between the first gravure plate cylinder and the blanket cylinder.

### BACKGROUND OF THE INVENTION

The present invention relates to a gravure offset printing press which uses a silicone blanket.

In a conventional gravure offset printing press, a proposal to form a blanket using a material with a low surface energy, such as silicone, has been presented as a high-resolution printing method. Silicone, for example, is used as the material of a blanket for the following two reasons. First, using a blanket with a surface energy sufficiently lower than that of ink, the ink can be prevented from wetting and spreading on the blanket upon being transferred onto the blanket. Thus, an image faithful to the pattern of a plate can be formed on the blanket.

Second, a full amount of ink can be transferred onto a printing object without generating discontinuities of the ink. In this case, it is necessary to set the conditions in which the ink has a sufficiently large cohesive force and does not suffer from excessive drying, both on the blanket. This makes it possible to prevent generation of defects resulting from, for example, pinholes produced in the printing object. The surface of the blanket is normally finished by, e.g., polishing in order to facilitate separation of the ink. Therefore, the ink surface after printing is an extremely smooth surface, which reproduces the structure of the blanket surface.

Japanese Patent Laid-Open No. 2005-186597, for example, describes a conventional gravure offset printing press having a silicone blanket. The printing press described in this reference includes an intaglio printing plate (intaglio cylinder) onto which ink is supplied, and a blanket cylinder which abuts the silicone blanket mounted on its circumferential surface against the intaglio printing plate to receive the ink from the intaglio printing plate. In this arrangement, the silicone blanket is separated from the intaglio printing plate and is thereupon brought into press contact with a transfer object to roll, thereby transferring the ink from the silicone blanket onto the transfer object to perform high-resolution printing.

In high-resolution printing which uses the above-mentioned silicone blanket, it is of prime importance to keep an optimum ink cohesive force that tends to vary due to solvent volatilization on the blanket. The degree of improvement in keeping the ink cohesive force optimum is determined by the following factors:

(1) the volume of ink on the blanket;

(2) the boiling point of a solvent in the ink and the addition ratio of the solvent;

(3) the ambient atmosphere of the blanket; and

(4) the time taken to transfer the ink onto a base material after it is transferred from the plate surface.

Of these factors, factors (2), (3), and (4) always stay the same regardless of the pattern of the plate. However, the amount (volume) of ink on the blanket, i.e., factor (1) greatly differs depending on the pattern of the plate, thus leading to degradation in printing quality.

That is, when ink corresponding to a pattern with a line width of 50 μm has a cohesive force optimum for transfer, it is fully transferred without remaining on the blanket. On the other hand, ink corresponding to a pattern with a line width of 10 μm on the same blanket is smaller in amount (volume) than ink corresponding to a pattern with a line width of 50 μm, so it suffers from excessive drying on the blanket and its full amount is not transferred onto the transfer object. This makes it extremely difficult to print various kinds of printing patterns with different line widths at once using only one blanket.

### SUMMARY OF THE INVENTION

It is an object of the present invention to provide a high-resolution printing press capable of printing various kinds of printing patterns with different line widths at once, and a printing method therefor.

In order to achieve the above-mentioned object, according to the present invention, there is provided a gravure offset printing press including a first gravure plate cylinder including, on a circumferential surface thereof, a first recess to be filled with ink, a second gravure plate cylinder including, on a circumferential surface thereof, a second recess which is to be filled with ink and has a width in a circumferential direction thereof, that is larger than that of the first recess, a blanket cylinder which comes into contact with the first gravure plate cylinder and the second gravure plate cylinder to receive the inks from the first gravure plate cylinder and the second gravure plate cylinder, and an impression cylinder which is opposed to the blanket cylinder with a printing object sandwiched between them, the printing object onto which the inks are transferred from the blanket cylinder, wherein a contact position between the second gravure plate cylinder and the blanket cylinder is located upstream, in a rotation direction of the blanket cylinder, of a contact position between the first gravure plate cylinder and the blanket cylinder.

### BRIEF DESCRIPTION OF THE DRAWINGS

FIG. 1 is a side view showing an array of cylinders of a gravure offset printing press according to the first embodiment of the present invention; and

FIG. 2 is a side view showing an array of cylinders of a gravure offset printing press according to the first embodiment of the present invention,

### DESCRIPTION OF THE PREFERRED EMBODIMENTS

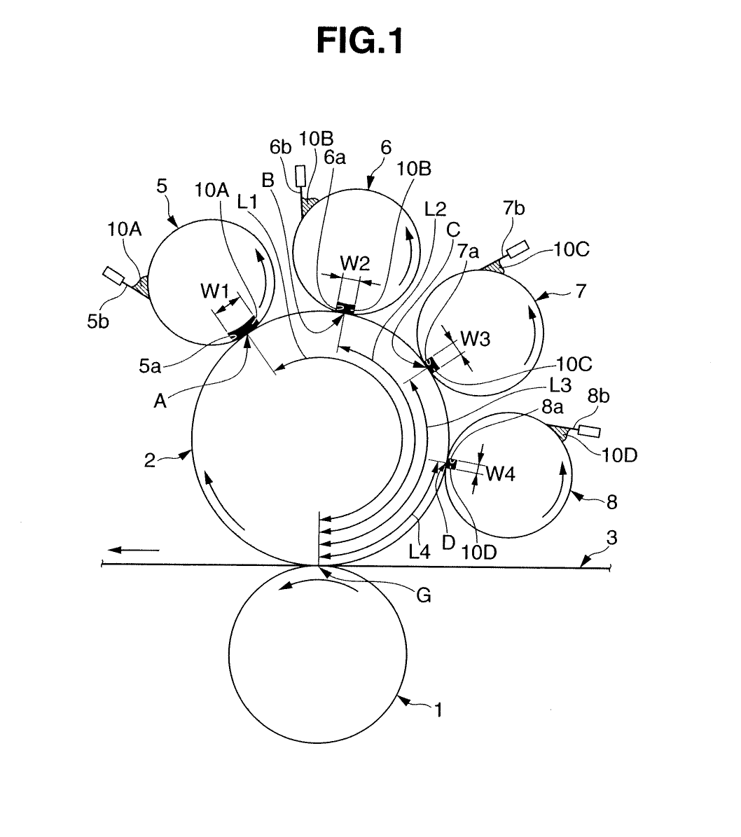

The first embodiment of the present invention will be described with reference to FIG. 1. A silicone blanket cylinder 2 with a diameter which is larger than that of an impression cylinder 1 and double that of gravure plate cylinders (to be described later) is opposed to the impression cylinder 1, as shown in FIG. 1. A transfer object 3 is supplied between the impression cylinder 1 and the blanket cylinder 2, and ink is transferred from the blanket cylinder 2 onto the transfer object 3 at a transfer position G at which the impression cylinder 1 and blanket cylinder 2 are opposed to each other.

Four gravure plate cylinders 5 to 8 are arranged on the blanket cylinder 2 from the upstream side to the downstream side in its rotation direction so as to come into contact with the circumferential surface of the blanket cylinder 2. The gravure plate cylinders 5 to 8 with the same diameter sequentially come into contact with the circumferential surface of the blanket cylinder 2 at contact positions A, B, C, and D, respectively.

Image areas including recesses 5a to 8a to be filled with inks 10A to 10D containing silver paste are formed on the circumferential surfaces of the gravure plate cylinders 5 to 8. Doctor blades 5b to 8b fill the recesses 5a to 8a with the inks 10A to 10D supplied from an ink supply device (not shown) onto the circumferential surfaces of the gravure plate cylinders 5 to 8. At the same time, the doctor blades 5b to 8b scrape away superfluous inks adhering on the circumferential surfaces of the gravure plate cylinders 5 to 8.

The recesses 5a to 8a in the gravure plate cylinder 5 have widths W1 to W4, respectively, in their circumferential directions. The widths W1 to W4 of the recesses 5a to 8a satisfy a relation:

W1>W2>W3>W4

The widths W1 to W4 of the recesses 5a to 8a determine the widths of lines running in the plate cylinder axis directions in the image areas. Note that FIG. 1 shows with exaggeration the widths W1 to W4 of the recesses 5a to 8a to be larger than their actual widths for the sake of descriptive convenience.

Let L1 be the circumferential length of the blanket cylinder 2 between the contact position A between the gravure plate cylinder 5 and the blanket cylinder 2, and the transfer position G at which the inks 10A to 10D are transferred from the blanket cylinder 2 onto the transfer object 3. Let L2 be the circumferential length of the blanket cylinder 2 between the contact position B between the gravure plate cylinder 6 and the blanket cylinder 2, and the transfer position G. Let L3 be the circumferential length of the blanket cylinder 2 between the contact position C between the gravure plate cylinder 7 and the blanket cylinder 2, and the transfer position G. Let L4 be the circumferential length of the blanket cylinder 2 between the contact position D between the gravure plate cylinder 8 and the blanket cylinder 2, and the transfer position G. The contact positions A to D are set such that the circumferential lengths L1 to L4 of the blanket cylinder 2 satisfy:

L1>L2>L3>L4

That is, the contact positions A to D between the gravure plate cylinders 5 to 8 and the blanket cylinder 2 are set such that a gravure plate cylinder including a recess with a relatively large width is positioned upstream, in the rotation direction of the blanket cylinder 2, of a gravure plate cylinder including a recess with a relatively small width. In this case, the gravure plate cylinders 5 to 7 are positioned upstream of the gravure plate cylinder 8 in the rotation direction of the blanket cylinder 2. The gravure plate cylinders 5 and 6 are positioned upstream of the gravure plate cylinder 7 in the rotation direction of the blanket cylinder 2. The gravure plate cylinder 5 is positioned upstream of the gravure plate cylinder 6 in the rotation direction of the blanket cylinder 2.

As a method of setting the contact positions A to D, first, the circumferential lengths L1 to L4 are calculated in proportion to the widths W1 to W4 of the recesses 5a to 8a to temporarily determine the contact positions A to D. Next, the contact positions A to D are finely adjusted so that the inks 10A to 10D have the same viscosity characteristics at the transfer position G. In this case, if optimum contact positions A to D can be obtained based simply on the proportionality between the widths W1 to W4 of the recesses 5a to 8a and the circumferential lengths L1 to L4, there is no need to finely adjust the contact positions A to D.

Upon setting the circumferential lengths L1 to L4, the inks 10A to 10D transferred from the gravure plate cylinders 5 to 8 onto the blanket cylinder 2 are further transferred from the blanket cylinder 2 onto the transfer object 3 while they are kept in nearly the same half-dry state (semidry state) and have nearly the same cohesive force at the transfer position G, in accordance with the widths W1 to W4 of the recesses 5a to 8a. Setting the circumferential lengths L1 to L4 amounts to setting the times taken to transfer the inks 10A to 10D onto the transfer object 3 at the transfer position G after they are transferred onto the blanket cylinder 2. During the set times, the inks 10A to 10D transferred onto the blanket cylinder 2 at the contact positions A to D are kept in nearly the same half-dry state in accordance with their amounts at the transfer position G and are thereupon further transferred onto the transfer object 3.

In the half-dry state, the inks 10A to 10D have a predetermined cohesive force or adhesive force with which they are transferred onto the transfer object 3 without remaining in the recesses 5a to 8a. Accordingly, the inks 10A to 10D in this half-dry state have a predetermined viscosity (coefficient of viscosity) intermediate between a fluid state as typified by a watery state and a completely dry state.

A printing operation in a gravure offset printing press with the above-mentioned arrangement will be described next. The doctor blades 5b to 8b fill the recesses 5a to 8a with the inks supplied from the ink supply device (not shown) onto the circumferential surfaces of the gravure plate cylinders 5 to 8.

The inks 10A to 10D which fill the recesses 5a to 8a are transferred onto the blanket cylinder 2 at the contact positions A to D, respectively. At this time, the circumferential surface of the blanket cylinder 2 partially enters the recesses 5a to 8a because the blanket cylinder 2 is made of elastically deformable silicone. Therefore, the blanket cylinder 2 which has entered the recesses 5a to 8a comes into t′ ht contact with the inks 10A to 10D which fill the recesses 5a to 8a, thereby reliably transferring the inks 10A to 10D onto the blanket cylinder 2.

Solvents contained in the inks 10A to 10D transferred onto the blanket cylinder 2 spontaneously evaporate while moving to the transfer position G. Therefore, the inks 10A to 10D dry to nearly the same half-dry state and have nearly the same cohesive force at the transfer position G. As a result, high-resolution printing can be performed by the inks 10A to 10D transferred onto the transfer object 3 with nearly the same cohesive force at the transfer position G.

An application example of the first embodiment will be described. In this application example, the inks 10A to 10D to be supplied from the gravure plate cylinders 5 to 8 have different properties (types), in addition to setting of the circumferential lengths L1 to L4 according to the first embodiment. More specifically, solvents with different boiling points can be used as solvents to be added to the inks, or the mixture ratio between an ink component and a solvent can be changed. Thus, the inks 10A to 10D transferred at the transfer position G can more accurately be kept in nearly the same half-dry state (cohesion state).

In the first embodiment described above, because the inks 10A to 10D which fill the recesses 5a to 8a in the gravure plate cylinders 5 to 8 that form image areas with different line widths dry to have nearly the same rheological characteristics at the transfer position G, no variation in cohesive force of the ink itself occurs. Thus, the transfer forces with which the inks 10A to 10D are transferred onto the transfer object 3 become nearly uniform, so the printing quality improves free from a variation in printing. As a result, various kinds of printing patterns with different line widths can be printed at once.

Also, because the inks 10A to 10D transferred onto the blanket cylinder 2 are kept in a half-dry state while moving to the transfer position G, a predetermined adhesive force can be obtained upon transferring them onto the transfer object 3. This improves the adhesive forces (cohesive forces) of the inks 10A to 10D with respect to the transfer object 3. As a result, the inks 10A to 10D can be reliably transferred onto the transfer object 3, so transfer failures reduce and the printing quality improves.

Moreover, because the surface energy of the blanket cylinder 2 decreases due to factors associated with the properties of silicone, the separation characteristics of the inks 10A to 10D upon transferring them onto the transfer object 3 improve. This smoothens the surfaces of the inks 10A to 10D transferred onto the transfer object 3, so a high-quality printing product can be obtained.

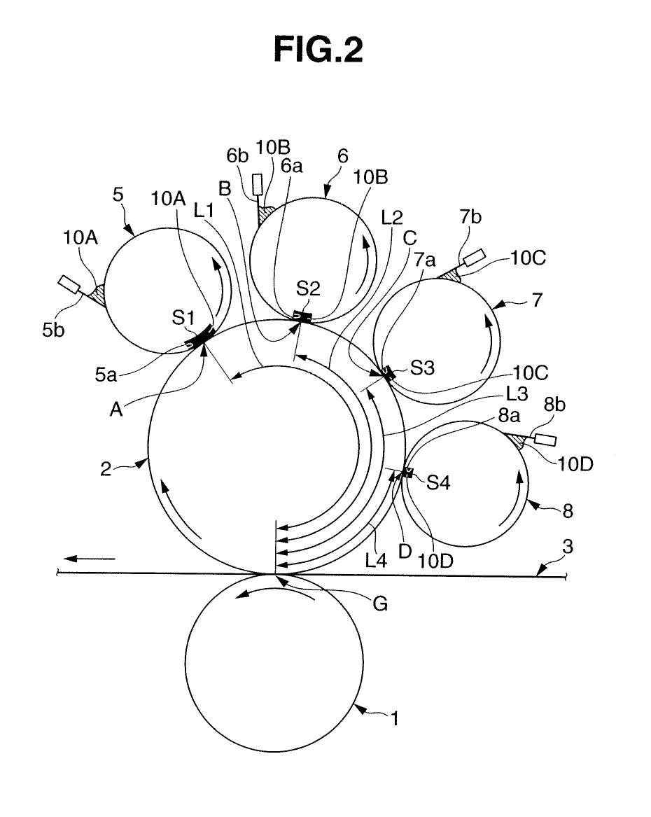

The second embodiment of the present invention will be described with reference to FIG. 2. In the first embodiment, the circumferential lengths L1 to L4 are set to obtain the contact positions A to D in accordance with the widths W1 to W4 of the recesses to 8a in the gravure plate cylinders 5 to 8 in their circumferential directions. In the second embodiment, the circumferential lengths L1 to L4 are set in accordance with the cross-sectional areas S1 to S4 of recesses 5a to 8a in gravure plate cylinders 5 to 8 in their circumferential directions, as shown in FIG. 2. That is, the gravure plate cylinders 5 to 8 are provided on a blanket cylinder 2 such that the recesses 5a to 8a with the cross-sectional areas S1 to S4 are arranged from the upstream side in descending order of cross-sectional area. According to the second embodiment, the circumferential lengths L1 to L4 are precisely set based on the amounts of inks 10A to 10D in the recesses 5a to 8a.

Although the entire blanket cylinder is made of silicone in each of the above-described embodiments, a blanket cylinder having a silicone blanket wound around its surface or a blanket cylinder on which a silicone film is formed may be used. Any blanket cylinder can be used as long as at least the portions onto which the inks are transferred from the gravure plate cylinders are formed from silicone. Also, the present invention is not limited to the silicone blanket cylinder 2, and a blanket cylinder made of PTFE (polytetrafluoroethylene) or PVDF (polyvinylidene fluoride) may be used. Again, any blanket cylinder can be used as long as the cylinder surface is formed from a material with a low surface energy and good separation characteristics.

As has been described above, according to the present invention, the inks transferred onto the printing object can have a predetermined, nearly uniform transfer force, so various kinds of printing patterns can be printed at once.

What is claimed:

1. A gravure offset printing press including
a first gravure plate cylinder including, on a circumferential surface thereof, a first recess to be filled with ink,
at least one second gravure plate cylinder including, on a circumferential surface thereof, a second recess which is to be filled with ink and has a width in a circumferential direction thereof, that is larger than the first recess,
a blanket cylinder which comes into contact with the first gravure plate cylinder and the second gravure plate cylinder to receive the inks from the first gravure plate cylinder and the second gravure plate cylinder, and
an impression cylinder which is opposed to the blanket cylinder with a printing object sandwiched between them, the printing object onto which the inks are transferred from the blanket cylinder, wherein
a contact position between the second gravure plate cylinder and the blanket cylinder is located upstream, in a rotation direction of the blanket cylinder, of a contact position between the first gravure plate cylinder and the blanket cylinder.

2. An apparatus according to claim 1, wherein
the contact positions between the first gravure plate cylinder and the second gravure plate cylinder, respectively, and the blanket cylinder are set in accordance with one of widths and cross-sectional areas of the recesses in the first gravure plate cylinder and the second gravure plate cylinder, respectively.

3. An apparatus according to claim 2, wherein
circumferential lengths of the blanket cylinder from the contact positions between the first gravure plate cylinder and the second gravure plate cylinder, respectively, and the blanket cylinder to a transfer position (G) at which the inks are transferred from the blanket cylinder onto a transfer object are proportional to one of the widths and the cross-sectional areas of the recesses in the first gravure plate cylinder and the second gravure plate cylinder, respectively.

4. An apparatus according to claim 1, wherein
the inks transferred from the first gravure plate cylinder and the second gravure plate cylinder onto the blanket cylinder at the respective contact positions are further transferred from the blanket cylinder onto the printing object while having a nearly identical degree of dryness.

5. An apparatus according to claim 1, wherein
the recesses in the first gravure plate cylinder and the second gravure plate cylinder, respectively, are filled with inks having different properties.

6. An apparatus according to claim 1, wherein
a surface of the blanket cylinder is made of a material with a low surface energy.

7. An apparatus according to claim 1, wherein
the inks which fill the recesses in the first gravure plate cylinder and the second gravure plate cylinder, respectively, contain silver paste.

8. An apparatus according to claim 1, wherein
a plurality of the second gravure plate cylinders are provided including the recesses which have different widths (W1-W3), and
a contact position (B-D) between the second gravure plate cylinder including the second recess with a relatively large width and the blanket cylinder is located upstream, in a rotation direction of the blanket cylinder, of a contact position between the gravure plate cylinder including the second recess with a relatively small width and the blanket cylinder.

9. A gravure offset printing press including
a plurality of gravure plate cylinders (5-8) including, on circumferential surfaces thereof, recesses (5a-8a) which are to be filled with inks (10A-10D) and have different widths (W1-W4) in circumferential directions thereof,
a blanket cylinder (2) which comes into contact with the plurality of gravure plate cylinders to receive the inks from the plurality of gravure plate cylinders, and
an impression cylinder (1) which is opposed to the blanket cylinder with a printing object (3) sandwiched between them, the printing object onto which the inks are transferred from the blanket cylinder, characterized in that
a contact position (A-D) between a gravure plate cylinder including a recess with a relatively large width and the blanket cylinder is located upstream, in a rotation direction of the blanket cylinder, of a contact position between a gravure plate cylinder including a recess with a relatively small width and the blanket cylinder.
